(19) United States
(12) Patent Application Publication
(10) Pub. No.: US 2006/0063147 A1
(43) Pub. Date: Mar. 23, 2006

(54) Omega-amino-PEG-phosphoramidites and conjugates thereof

(76) Inventors: Boris K. Chernov, Willowbrook, IL (US); Alexander Kukhtin, Lockport, IL (US); Julia B. Golova, Willowbrook, IL (US)

Correspondence Address: BARNES & THORNBURG, LLP, P.O. BOX 2786, CHICAGO, IL, 60690-2786, US

(21) Appl. No.: 10/945,834

(22) Filed: Sep. 21, 2004

(51) Int. Cl. C40B 40/08

(52) U.S. Cl. 435/5; 435/6; 536/25.3

(57) ABSTRACT

ω-Amino-PEG conjugates, and processes and reagents for preparing ω-amino-PEG conjugates are described.

The United States Government has rights in the disclosed invention pursuant to Contract No. W-31-109-ENG-38 between the U.S. Department of Energy (DOE) and the University of Chicago representing Argonne National Laboratory.

Polyethylene glycol conjugates, and processes and reagents for preparing such conjugates are described, in particular, polyethylene glycol conjugates of oligonucleotides.

### BACKGROUND

Conjugates are formed from molecules of interest for a wide range of applications. Some conjugates are formed to affect the physical properties of a molecule, while others are formed to affect the biological and/or pharmacological properties of the molecule. Still other conjugates are formed to allow molecules of interest to be immobilized on solid supports for further study, chemical synthesis, and use as diagnostic tools.

Generally, when oligonucleotides are attached to solid supports, the conjugate includes a 3′- or 5′-modification that allows immobilization of the oligonucleotides on the support. Such solid supported oligonucleotides may be used as DNA probes, including in DNA-based microarrays. These microarrays may in turn be used as biochips for on-chip PCR. In order to covalently attach oligonucleotides to solid supports, the 3′- or 5′-modification must include a functional group capable of reacting with other functional groups on the surface of the solid support. For example, 3′- or 5′-modifications that include an amino group may be reacted with carbonyl groups, activated carboxylic acid derivatives, and/or activated sulfonic acid derivatives, and the like on solid support surfaces. These reactions form the corresponding amides, sulfonamides, amines, and the like with solid supports.

For example, oligonucleotide conjugates formed from 3-(trifluoroacetylamino)propyl-(2-cyanoethyl)-(N,N-diisopropyl)phosphoramidite; 6-(4-monomethoxytritylamino)hexyl-(2-cyanoethyl)-(N,N-diisopropyl)phosphoramidite; 6-(trifluoroacetylamino)hexyl-(2-cyanoethyl)-(N,N-diisopropyl)phosphoramidite; 12-(4-monomethoxytritylamino)dodecyl-(2-cyanoethyl)-(N,N-diisopropyl)phosphoramidite; 2-[2-(4-monomethoxytrityl)aminoethoxy]ethyl-(2-cyanoethyl)-(N,N-diisopropyl)phosphoramidite; and [(6-trifluoroacetylamidocaproamidomethyl)-1-(2-nitrophenyl)-ethyl]-2-cyanoethyl-(N,N-diisopropyl)phosphoramidite have been reported. (See, GLEN Research, Sterling, Va; Pirrung; Charles)

Polyethylene glycol (PEG) is a polyether diol of the general structure HO(CH₂CH₂O)ₙCH₂CH₂OH, where n is an integer that may represent a narrow or wide range of molecular weights of the PEG depending on the source or nature of the PEG. PEG is a biocompatible polymer that possesses a number of useful properties, including a wide range of solubility in both organic and aqueous media, a lack of toxicity and immunogenicity, and stability against enzymatic degradation, like nucleases and proteases.

Because of the desirable combination of physical, chemical, and biological properties exhibited by polyethylene glycols, they have been used to prepare conjugates of molecules that may themselves be analyzed or that may be used in the analysis of other molecules. For example, PEG has been used as a modifier to prepare conjugates with many classes of biological macromolecules (see generally, Zalipsky).

PEG conjugates of oligodeoxyribonucleotides, also generally referred to as PEGylated oligonucleotides, have also been reported. Recently both the number of and applications for PEG-oligonucleotide conjugates have increased. Oligoethylene glycols have also been used as linkers for coupling oligonucleotides to membranes and glass surfaces, for construction of loops in stem-loop structures, and for making circular oligodeoxyribonucleotides. PEG-conjugates with antisense or antigen oligonucleotides have been used as inhibitors of gene expression, owing to the enhanced of stability and cell membrane permeability of the conjugates without producing undesirable toxic effects.

To realize the full potential of PEG conjugates, modification of the terminal hydroxy group is needed. Such a modification will extend the recognized utility of PEG-based linkers in the analysis of molecules of biological importance.

### SUMMARY OF THE INVENTION

ω-Amino-PEGs extend the capability of using PEGs in the formation of conjugates for use as therapeutic agents, and as analytic and diagnostic tools in molecular biological investigations. ω-Amino-PEG-oligonucleotide conjugates further extend this capability. In addition, the presence of an active amino group on the conjugate provides for further modification of the conjugate with fluorescent dyes, reference molecules or others labels, and also allows using conjugates as probes for immobilization on supports, such as glass slides, plastic slides, gel elements, and the like.

A novel composition is described that is useful as a reagent for the direct production of ω-amino-PEG derivatives or conjugates of various molecules, including oligonucleotides, drugs, affinity ligands, peptides, proteins, carbohydrates, antibiotics, diagnostic and other reporting groups, and the like. Conjugates of ω-amino-PEG-phosphoramidites with these various molecules are also described. Processes for preparing these reagents and the conjugates that are produced from these reagents are also described. Kits that employ the processes and reagents described herein are also described. In particular, conjugates formed from oligonucleotides and the ω-amino-PEG modifying agents described herein may be prepared as part of, and during, conventional automated chemical synthesis of such oligonucleotides, including conventional syntheses conducted on commercially available instruments.

In addition, conjugates formed from oligonucleotides, or other molecules described herein may be immobilized by covalent attachment to solid supports, such as glass slides, plastic slides, silicon, gold slides, gel pads, acrylamide matrices, and the like. Alternatively, these and other conjugates may be subsequently coupled to diagnostic agents or reporting agents, such as biotin, fluorescent labels, antibodies and the like, or coupled to other molecules or substrates that may be needed for the evaluation of the oligonucleotides themselves or other molecules.

In one embodiment, an oligonucleotide conjugate of the following formula is described: 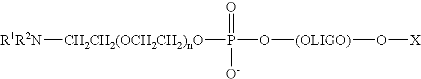
wherein R¹ and R² are each independently selected from the group consisting of hydrogen, amino protecting groups, a first solid support, and a first diagnostic agent; or R¹ and R² are taken together to form an amino protecting group, a first solid support, or a diagnostic agent; n is an integer in the range from about 8 to about 200; OLIGO is an oligonucleotide; and X is hydrogen, or a second solid support, or a second diagnostic agent.

In another embodiment, a terminal amino polyethylene glycol conjugate of the following formula is described: 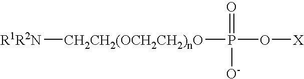
wherein R¹ and R² are each independently selected from the group consisting of hydrogen, amino protecting groups, a first solid support, and a first diagnostic agent; or R¹ and R² are taken together to form an amino protecting group, a first solid support, or the first diagnostic agent; n is an integer in the range from about 8 to about 200; and X is a molecule selected from the group consisting of oligonucleotides, peptides, proteins, carbohydrates, biotin, diagnostic agents, fluorescent labels, drugs, affinity ligands, and antibiotics.

In another embodiment, a reagent for preparing conjugates, where the reagent comprises a compound of the following formula is described:
R¹R²N-CH₂CH₂-(O-CH₂CH₂)ₙ-OX
wherein R¹ and R² are each independently selected from the group consisting of hydrogen, amino protecting groups, a first solid support, and a first diagnostic agent; or R¹ and R² are taken together to form a amino protecting group; n is an integer in the range from about 8 to about 200; and X is hydrogen, an hydroxyl protecting group, or an optionally protected derivative of trivalent phosphorus.

In another embodiment, a process for preparing conjugate reagents is described, where the process comprises the step of:

converting a first compound of formula:
R³-CH₂CH₂-(O-CH₂CH₂)ₙ-OR⁴
to a second compound of formula:
N₃-CH₂CH₂-(O-CH₂CH₂)ₙ-OR⁴
where R³is a leaving group; R⁴ is a hydroxyl protecting group; and n is an integer in the range from about 8 to about 200.

In another embodiment, a process for preparing oligonucleotide conjugates is described, where the process comprises the steps of:

(a) providing a solid support adapted for oligonucleotide synthesis

(b) synthesizing an oligonucleotide;

(c) deprotecting the 5′-OH of the oligonucleotide

(d) reacting the deprotected 5′-OH the oligonucleotide with a reagent comprising a compound of the formula:
R¹R²N-CH₂CH₂-(O-CH₂CH₂)ₙ-OX
wherein R¹ and R² are each independently selected from the group consisting of hydrogen and amino protecting groups, provided that at least one of R¹ and R² is not hydrogen; or R¹ and R² are taken together to form an amino protecting group; n is an integer in the range from about 8 to about 200; and X is an optionally protected derivative of trivalent phosphorus.

In another embodiment, a biochip is described, where the biochip comprises a solid support, and a plurality of oligonucleotide conjugates of the following formula: 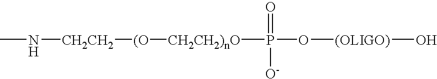
wherein n is an integer in the range from about 8 to about 200; and OLIGO is in each occurrence an independently selected oligonucleotide; and where each of the plurality of oligonucleotide conjugates is covalently attached to the solid support.

In another embodiment, a kit for preparing a biochip is described, where the kit comprises (a) a solid support; and (b) an agent for covalently attaching one or more oligonucleotide conjugates to the solid support. The oligonucleotide conjugates have the following formula: 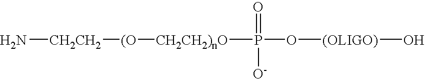
wherein n is an integer in the range from about 2 to about 200; and OLIGO is in each of the one or more oligonucleotide conjugates an independently selected oligonucleotide.

### DEFINITIONS AND ABBREVIATIONS

Aminomodifler: a chemical that provides at least one functional amino group to a molecule, illustratively an oligonucleotide. Aminomodifiers may be used to immobilize the molecule on a solid support or to introduce any of a variety of other chemical modifications, such as conjugating to diagnostic agents, fluorescent dyes, biotin, antibodies, and the like.

Array, microarray: a predetermined arrangement of molecules relative to each other connected to a support, also referred to as a chip, DNA chip, DNA microarray, DNA array, microchip, peptide chip, or peptide array. Illustratively, the array is a predetermined arrangement of biological molecules such as DNA fragments, peptides, proteins, lipids, drugs, affinity ligands, and the like.

Hybridization: the formation of duplex molecules from complementary single strands of nucleic acids, including DNA-DNA, DNA-RNA, and RNA-RNA duplexes.

One single stranded nucleic acid molecule is illustratively labeled, such as labeling with a detectable (radioactive or fluorescent) dye and is used as a probe that may anneal to complementary or nearly complementary nucleic acid single strands depending upon the stringency conditions. Conditions are varied to detect degrees of similarity, i.e. the more stringent the conditions, the greater the complementarity needed for hybridization to occur.

Nucleic acids: genetic material including single and double stranded deoxyribonucleic acids (DNA) and ribonucleic acids (RNA), and including DNA-RNA hybrids.

Oligomer or oligonucleotide: A nucleotide sequence (DNA or RNA) having about 6 or more nucleotides, and illustratively in the range from about 6 to about 100 nucleotides.

Support: a glass slide, silicon, gold slide, gel pad, acrylamide matrix, or other similar structure on which an array or a microarray of molecules is formed. Illustrative supports include functional groups on their surfaces to allow attachment, including covalent attachment, of biomolecules to the support.

Tethering: the manner of immobilization of biomolecules on a support.

Linker: a polyfunctional molecule optionally connected to a support or adapted for connection to a support; containing functional groups that may provide oligomer chain elongation during solid phase oligonucleotide synthesis; and illustratively including a free amino functional group for post synthesis treatment procedures, including attachment to a support.

CPG—control pore glass or controlled pore glass.

LC CPG—long chain control pore glass or long chain controlled pore glass.

DMTr—4,4′-dimethoxytrityl protecting group.

Tfa—trifluoroacetyl protecting group.

NOSH—N-hydroxysuccinimide.

PAAG—polyacrylamide gel.

SSPE—saline-sodium phosphate-EDTA buffer.

EDTA—ethylenediamine tetraacetic acid.

DMF—dimethylformamide

DMSO—dimethyl sulfoxide

Triton X—100 - polyethyleneglycol (n=9, 10), octylphenoxypolyethoxyethanol.

HEPES—N-2-hydroxyethylpiperazine-N'-2-ethanesulphonic acid.

UV—ultraviolet.

HPLC—high pressure liquid chromatography.

PCR—Polymerase chain reaction. A method used to make multiple copies of DNA.

Phosphoramidite—phosphoramide derivatives of nucleosides used in chemical solid phase oligonucleotide synthesis.

Antisense—an oligonucleotide or analog thereof that is complementary to a segment of RNA or DNA and that binds to it and inhibits its normal function.

Antigene, Antigen—a substance that can trigger an immune response, resulting in production of an antibody as part of the body's defense against infection and disease.

TEAA—triethylammonium acetate buffer.

### BRIEF DESCRIPTION OF THE DRAWINGS

FIG. 1 shows an illustrative chemical synthesis of one embodiment of the ω-amino-PEGylating reagent, compound (7), and its use in preparing a 5′-oligonucleotide conjugate, compound (8), where the reagents and conditions are: a) 4,4′-dimethoxytrityl chloride, pyridine; b) methansulfonyl chloride, pyridine, triethylamine; c) sodium azide, N,N-dimethylformamide; d) triphenylphosphine, pyridine-ammonium hydroxide; e) 9- fluorenylmethoxycarbonyl (Fmoc) succinimide, acetonitrile; then 80% acetic acid; f) 2-cyanoethyl tetraisopropylphosphorodiamidite, tetrazole, acetonitrile.

FIG. 2 shows a reversed-phase HPLC profile of the unpurified reaction mixture obtained from preparing compound (8), where OLIGO-OH is 5′-agcttcagtaccagtccggg-3′-OH, and n is 14-26 (Column RPR-1, 7×100 mm; gradient 5%-30% acetonitrile in 0.05 M TEAA; flow 2.5 ml/min; UV detection at 280 nm).

FIG. 3 shows MALDI MS of compound (8), where OLIGO-OH is 5′-agcttcagtaccagtccggg-3′-OH, and n is 14-26; calc. (for n=19) (M⁺) 7144.1, found (for n=19) (M⁺) 7144.6.

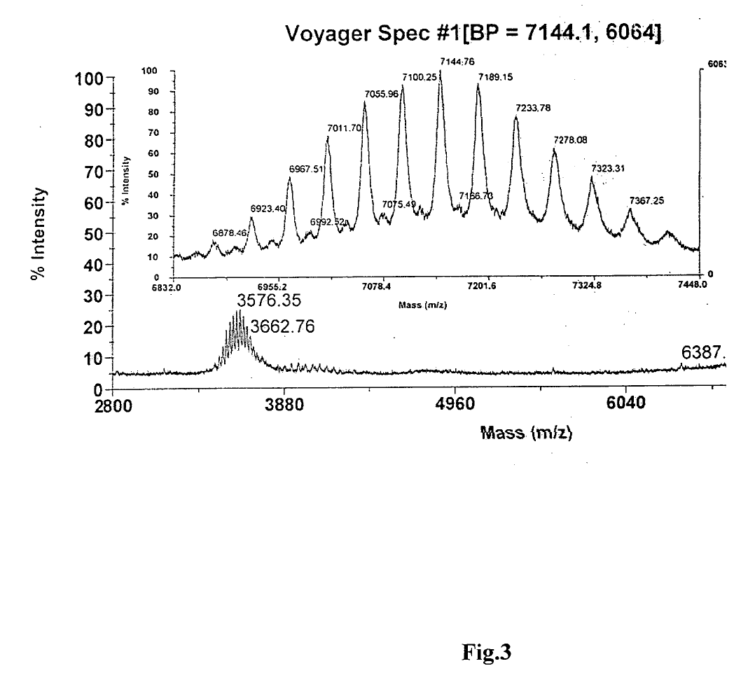

### DETAILED DESCRIPTION

Conjugates of biological molecules of interest and polyethylene glycols (PEGs) for use in research, to facilitate analyses, and as diagnostic agents are described. It has been found that PEG conjugates exhibit several unexpected and unique combinations of physical, chemical, and biological properties, many of which may be exploited through the preparation of conjugates with other molecules.

In one embodiment, PEG conjugates of various kinds of probes to be used in biochip technology are described. In particular, amino-modified PEG conjugates are used as linker systems for the immobilization of genetic probes on various solid supports, including glass and/or plastic surfaces, controlled pore glass supports, gels, including 2D and 3D supports, polyacrylamide gels, polyacrylamide gel pads, and the like. In one aspect, such probes immobilized on supports can be used for on-chip PCR. The reagents for preparing PEG conjugates described herein include a terminal amino group for attaching the molecules to be studied, such as oligonucleotide probes, on supports.

In another embodiment, oligonucleotide conjugates of the following formula are described: 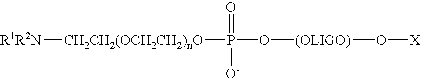
wherein R¹ and R² are each independently selected from the group consisting of hydrogen, amino protecting groups, a first solid support, and a first diagnostic agent; or R¹ and R² are taken together to form an amino protecting group, a first solid support, or a diagnostic agent; n is an integer in the range from about 8 to about 200; OLIGO is an oligonucleotide; and X is hydrogen, or a second solid support, or a second diagnostic agent.

In one aspect, R¹ is hydrogen and R² is an amino protecting group. Virtually any amino protecting group may be used in the oligonucleotide conjugate, such as the protecting groups that are described by Greene and Wuts (1991), the disclosure of which is incorporated herein by reference. It is appreciated that the choice of an amino protecting group may depend upon other protecting groups that are used in the synthesis to produce the conjugates described herein, including the degree of selectivity that may be achieved in removing the amino protecting group or preventing the removal of the amino protecting group compared to manipulating other protecting groups present on the conjugates. In one embodiment of the amino protecting groups, conjugates include amino protecting groups that are stable to acidic reaction conditions, and/or amino protecting groups that may be removed under basic conditions, or under certain neutral conditions.

In another aspect, both R¹ and R² are hydrogen. In this aspect, such conjugates may be further conjugated with other molecules, including but not limited to drugs, antibodies, diagnostic agents or other reporting agents, labels, such as fluorescent labels, biologically important labels, such as antigens, biotin, and the like. In addition, in this aspect, such conjugates may be immobilized on supports, including but not limited to 2D and 3D solid supports such as control pore glass, glass microscope slides, plastic slides, gels such as polyacrylamide gels, and the like.

In another aspect, the length of the PEG portion of the conjugate is about 9 or greater than 9 (i.e., n=8, or n>8) ethylene units length. In another aspect, the PEG portion is not greater than about 200 ethylene units length. In still another aspect, the PEG portion falls within the range of about 10 to about 30, or about 14 to about 26 ethylene units in length.

In another aspect, the first solid support is a support adapted for or suitable for analyzing other molecules, including but not limited to control pore glass, glass slides, plastic slides, and polyacrylamide gel pads. In particular, the first solid support is a support adapted for or suitable for performing PCR, such as on-chip PCR. In another aspect, the second solid support is a support adapted for or suitable for performing an oligonucleotide synthesis. It is to be understood that conventional and commercially available supports of this nature are included in this aspect of the second solid support.

In another aspect, the first and/or second diagnostic agents include but are not limited to reporting agents, such as antibodies, antigens, fluorescent agents, such as derivatives of fluorescein isothiocyanate (FITC), and the like.

The oligonucleotides are attached to the conjugates described herein at the 5′-end. This latter aspect of attachment may result from the automated or other solid phase synthesis of the oligonucleotide as described herein.

In one embodiment of the oligonucleotide conjugates described herein, a compound of the formula. 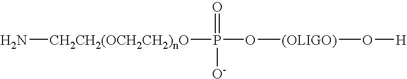
is described herein, where n is an integer in the range from about 14 to about 26, and OLIGO is an oligonucleotide connected to PEG at the 5′-end via a phosphodiester group. Such conjugates may be prepared from PEG 900 according to the processes described herein.

In another aspect, the amino polyethyleneglycol fragment of the conjugates described herein is regarded as a linker. Similarly, the amino polyethyleneglycol fragment taken together with the phosphoryl fragment of the conjugates described herein is regarded as a linker. In these cases, the linker allows the conjugates to be extended to conjugate with another molecule or substrate as described herein.

In another embodiment, reagents for preparing conjugates are described. Illustrative reagents include compounds of the formula:
R¹R²N-CH₂CH₂-(O-CH₂CH₂)ₙ-OX
wherein R¹ and R² are each independently selected from the group consisting of hydrogen, amino protecting groups, a first solid support, and a first diagnostic agent; or R¹ and R² are taken together to form an amino protecting group; n is an integer in the range from about 2 to about 200; and X is hydrogen, an hydroxyl protecting group, or an optionally protected phosphorus coupling agent.

It is to be understood that the amino protecting groups, the first solid support, the first diagnostic agent, the hydroxyl protecting group, the values selected for the integer n, and the selections generally made for the groups R¹ and R² are similar to those described for other embodiments. In one aspect, X is hydrogen. This aspect may be prepared from a reagent described herein where X is a hydroxyl protecting group. In another aspect, X is an optionally protected derivative of trivalent phosphorus. This aspect may be prepared from a reagent described herein where X is hydrogen. In this latter aspect, the derivative of trivalent phosphorus includes suitable substituted phosphoramidites, such as (2-cyanoethyl)-N,N-diisopropylphosphoramidite fragments, that may be used in conventional oligonucleotide synthetic protocols or machinery.

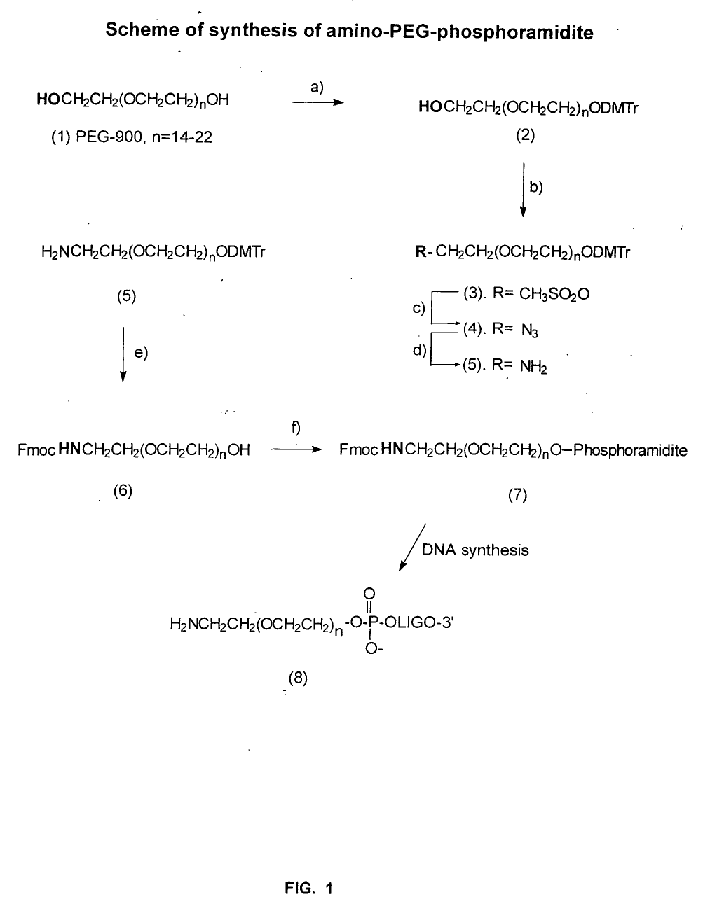

In another embodiment, processes for preparing the reagents and conjugates are described herein. FIG. 1 shows an illustrative chemical synthesis of a reagent derived from PEG-900. It is appreciated that this synthesis may be generalized for other PEGs of various lengths, or mixtures of PEGs falling within predetermined ranges of lengths. The PEGs (1) used in this synthesis are obtained from commercial sources or alternatively prepared by conventional processes. PEGs (1) are protected at one terminal hydroxyl with a suitably selected hydroxyl protecting group, such as any hydroxyl protecting group, like optionally substituted trityl that may be removed under acidic reactions conditions, illustratively monomethoxytrityl or dimethoxytrityl (DMTr). Illustratively, PEGs (1) are treated with optionally substituted trityl chloride in presence of organic bases. Suitable bases amine bases, such as triethylamine, Hünig's base, pyridine, lutidine, and the like. Suitable solvents include non-protic solvents such as methylene chloride, tetrahydrofuran, ether, dichloroethane, acetonitrile, ethyl acetate, and the like.

The monoprotected PEGs (2) are converted to monoprotected amino-PEGs (5) in three steps. Intermediate compounds may be purified, or the isolated material may be carried on to the next step without purification. Step 1 involves converting the remaining free hydroxyl to a leaving group, such as a halide, acyloxy, alkylsulfonyloxy, arylsulfonyloxy, and the like, and including chloro, bromo, iodo, mesyl, tosyl, brosyl, nosyl, mesityl, trifluoromethanesulfonyl, and the like. Suitable solvents include acetonitrile, methylene chloride, tetrahydrofuran, dichloroethane, and the like. Illustratively, monoprotected PEGs (2) are treated with a sulfonyl chloride in the presence of bases to give the corresponding sulfonyloxy derivatives (3). Step 2 involves nucleophilically displacing the leaving group with azide. The leaving group, such as the illustrative sulfonyloxy shown in FIG. 1 are displaced by azide to give the corresponding monoprotected azido PEGs (4) by treating sulfonyloxy derivatives (3) with a source of azide, such as sodium azide, in a polar solvent, including dipolar aprotic solvents such as DMF and DMSO. Step 3 involves reduction of the azide to an amide to give hydroxyl-protected ω-amino-PEGs (5) with a reducing agent, such as triphenylphosphine, ferrous ammonium chloride, borohydride and aluminum hydride reagents, lithium aluminum hydride, zinc borohydride, and the like.

The amino function of hydroxyl-protected ω-amino-PEGs (5) is protected with an amino protecting group to give N,O-diprotected PEGs, which may be optionally isolated. Generally, the N,O-diprotected PEGs are not isolated, but are treated with a reagent to remove the hydroxyl protecting group to give the N-protected amino-PEGs (6) in a one-flask procedure. Illustratively, the amino protecting group is one that is removable under basic conditions, including the 9-fluorenylmethoxycarbonyl (Fmoc) protecting group. It is appreciated that a protecting group that allows simple detection of the amino-PEGs may be preferred, such as protecting groups that may be observed under UV, fluorescence, and the like. Illustratively, after attachment of the Fmoc group, the DMTr protecting group is removed under acidic conditions, such as by treatment with acetic acid, dichloroacetic acid (DCA) trichloroacetic acid, trifluoroacetic acid, and the like. Suitable solvents include chlorinated solvents, acetonitrile, ethyl acetate, and in some cases tetrahydrofuran and ether.

Reagents that are to be used for oligonucleotide conjugates, or other conjugates are converted to phosphoramidites (7), for subsequent coupling to nucleophilic compounds, such as oligonucleotides.

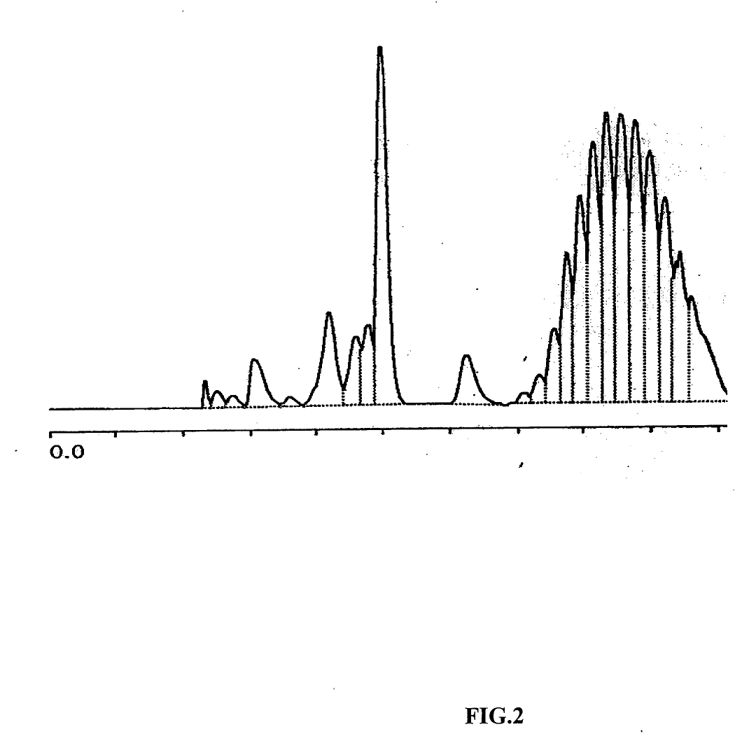

In particular, phosphoramidites (7) are used as a building block in conventional or automated solid phase oligonucleotide synthesis to obtain ω-amino-PEG-oligonucleotides. In one illustrative example, PEG-900 was treated as described herein and shown in FIG. 1. The HPLC trace of the resulting product phosphoramidite (7) is shown in FIG. 2, where OLIGO is agcttcagtaccagtccggg, attached at the 5′-end.

Conventional oligonucleotide syntheses that may be practiced in the processes described herein include those that use standard nucleoside (2-cyanoethyl)-N,N-diisopropy]phosphoramidite methods, also known as phosphoramidite methods. The N-protected ω-amino-PEG-(2-cyanoethyl)-N,N-diisopropylphosphoramidite reagents described herein may be used as one of the possible reagents in such syntheses. These reagents are activated with 1H-tetrazole, and coupled to the 5ω-terminus of the oligonucleotides under the standard synthesis conditions used with many commercial oligonucleotide synthesizers. Subsequent de-protection and purification using conventional methods provides the 5′-(ω-amino-PEG) oligonucleotide conjugates. These conjugates may be subsequently coupled via the terminal amino group with solid supports, such those used in the manufacture of biochips, glass slides, plastic slides, silicon, gold slides, gel pads, acrylamide matrices, and the like. Alternatively, these conjugates may be subsequently coupled to diagnostic agents or reporting agents, such as biotin, fluorescent labels, antibodies and the like, or coupled to other molecules or substrates that may be needed for the evaluation of the oligonucleotides themselves or other molecules.

Using PEG derivatives for preparing conjugates with oligonucleotides by an automated solid phase phosphoramidite method was reported by Jäschke et al. (1994). Following those general methods, the coupling efficiency of the PEG-phosphoramidites described herein to oligonucleotide chains synthesized according to such standard automated solid phase syntheses was about 70-80%. In contrast, introduction of amino-function into PEG-oligonucleotide conjugate using conventional commercially available 5′-amino-modifiers (Glen Research) proceeded with lower overall yields, not exceeding 50-60%. It is believed that the low nucleophilic properties of the PEG primary hydroxyl group and the unpredictable kinetic effects caused by the length of the polyethylene glycol chain accounts for these low yields.

In another aspect, the ω-amino-PEG- phosphoramidite conjugating reagents disclosed herein are used to prepare conjugates in one step rather than the two steps required with the conventional commercially available 5′-amino-modifiers. In processes using automated solid phase oligonucleotide synthesis, the conjugates are formed in the last step under the conditions of a standard reaction cycle, and with an efficiency of about 95-98% for the coupling reaction.

Immobilization of the conjugates on one or more supports is also described herein.

In one embodiment, the conjugate is an oligonucleotide conjugate. Immobilization, such as to prepare a biochip for PCR is contemplated. Depending upon the nature of the support, the conjugate is attached at the amino group with a suitable reagent. In one illustrative aspect, the support includes carbonyl functional groups and attachment is performed by reductive amination using conventional methods, such as by treatment with a borohydride reagent, such as sodium borohydride or sodium cyanoborohydride. In another illustrative aspect, the support includes carboxylic or sulfonic acids or derivatives thereof. Attachment in this aspect is performed by activating the surface of the support, such as by converting the carboxylic or sulfonic acid residues or derivatives thereof into the corresponding chlorides, anhydrides, and the like. It is appreciated that conventional amide forming and peptide coupling reagents and methods are applicable herein to perform attachment of the terminal amino conjugates to the solid supports in this aspect.

Illustratively, it has been observed that the direct synthesis of amino-PEG-oligonucleotide conjugates using amino-PEG-phosphoramidites, as described herein, in solid phase oligonucleotides synthesis is accomplished. In one aspect, co-amino-PEG-900-oligonucleotides were synthesized, and were successfully used for on-chip PCR experiments. It was demonstrated that amino-PEG-oligonucleotides synthesized by the disclosed method works with the same or better efficiency as a conjugate obtained by previously described two-step procedures using conventional aminoalkyl PEG conjugates.

It is appreciated that the length and structure of the PEG linker groups described herein that are used to prepare conjugates of PCR primers may affect the efficiency of the subsequent PCR on a microchip. For example, steric hindrances may affect the polymerase reaction by impeding the attachment of the Taq DNA polymerase to oligonucleotide primers tethered to the solid support. In cases where the oligonucleotide probes are near to or directly abut the supporting surface, steric hindrance may be increased. Without being bound by theory, it is believed that oligonucleotide probe conjugates prepared from the reagents and by the processes described herein may decrease the steric hindrance that accounts for decreased efficiencies observed during PCR.

In one aspect, illustrative conjugates prepared from the PEGylating reagents described herein are greater than about 8 units in length. In another aspect, the PEGylating reagent is about 200 ethyleneoxy units in length or less. In another aspect, the PEGylating reagents described herein are between about 8 and about 200, between about 6 and about 200, and/or between about 10 and about 30 ethyleneoxy units in length.

As disclosed herein, the amino terminal PEG-conjugates are of comparable or significantly longer lengths than those obtained using commercially available oligoethylene glycol phosphoramidites. For example, it has also been shown that 5′-hexaethylene glycol spacers tend to reduce or even eliminate steric factors that impede hybridization, and lead to increased efficiency of solid-phase PCR carried out in microwells. Carmon et al. (2002) has reported that the yield of solid-phase PCR reaction is significantly higher for oligonucleotides connected to the surface through muliplex hexaethylene glycol linkers than oligonucleotides directly connected to the support.

However, conventional linkers, such as those supplied by GLEN Research, often require at least two synthetic steps for attachment to the oligonucleotide, and typically give yields of conjugates in the range of about 50-60%. In addition, the efficiency of the subsequent PCR is typically lower than is found with conjugates described herein, or prepared from reagents described herein.

Conjugates formed from the terminal amino PEG linkers described herein may be prepared using standard synthetic procedures in a single step with general yields of about 95-97%.

Examples of automated oligonucleotide syntheses instrumentation include ABI-394 DNA-RNA synthesizer (Applied Biosystems, Foster City, CA), Biosearch Cyclone, Biosearch 8000 Series, Expedite, Beckman Oligo 1000, Pharmacia Gene Assembler, Integrated DNA Technologies synthesizers, and others. It is appreciated that ω-amino-PEG phosphoramidites disclosed here can be applied in these synthesizers in standard parameters of reaction sycle with usage of standard supplies, procedures, chemical reagents and solvents on each step of automated solid-phase oligonucleotide synthesis.

It is further appreciated that many of the materials and reagents, including those that are used in the processes disclosed herein, may be included in a kit format. Illustratively, the kit may include the reagents used for preparing a conjugate of a molecule of interest, and/or for preparing a biochip from conjugates disclosed herein. Illustratively, the kit includes the reagents and materials that are disclosed for use in the processes disclosed herein for preparing a biochip that has a plurality of terminal amino-PEG oligonuclotide conjugates covalently attached thereto.

The foregoing discussion and the following examples are intended to provide further illustration of the disclosures. However, neither the foregoing discussion nor the following examples should be considered as limiting the invention in any way. For example, it is to be understood that the reagents and processes disclosed herein may also be used to make a wide variety of conjugates with other molecules of interest that desirably are able to react with an amino group. Included with these molecules of interest are drugs, affinity ligands, peptides, proteins, oligonucleotides, carbohydrates, antibiotics, diagnostic and other reporting groups, and the like. It is appreciated that conjugation of such molecules may be performed to modify certain physical, biological, pharmacological, and/or other property. For example, drugs may be modified to improve solubility, for controlled release formulations, and/or for improved longevity and/or stability in the bloodstream (see generally, Zalipsky); affinity ligands may be modified to facilitate purification and analysis of other biomolecules and/or cells; peptides may be conjugated to improve solubility, for conformational analysis, and/or to decrease their immunogenicity and/or antigenicity; proteins may be conjugated to increase resistance to proteolysis, and/or reduce immunogenicity; carbohydrates may be conjugated to create new biomaterials, and/or drug carriers; oligonucleotides may be conjugated to improve solubility, increase resistance to nucleases, and/or increase cell membrane permeability.

### EXAMPLES

Example 1. Mono-(4,4′-dimethoxytrityl)PEG 900 (2). PEG 900 (10 g, 1.11 mmol, (1)) was evaporated three times with anhydrous pyridine, then dissolved in 100 ml of dry pyridine, to which 4,4′-dimethoxytrityl chloride (3.7 g, 1.11 mmol) was added. After stirring for 24 hours at room temperature, methanol (3 ml) was added and the solution was evaporated. The residue was dissolved in chloroform (150 ml), and sequentially washed with saturated aqueous sodium bicarbonate (2×75 ml) and water (80 ml), dried (sodium sulfate), and concentrated in vacuum. Purification by silica gel column chromatography (0-4% methanol gradient in chloroform) gave 5.6 g of (2) (42% based on PEG 900); MALDI MS: calc. (for n=19) (M⁺) 1200; found (M+H)⁺1201.

Example 2. α-4,4′-Dimethoxytrityl-ω-amino-PEG 900 (5).

Step 1. α-dimethoxytrityl-ω-methylate (3). Dimethoxytrityl-PEG 900 (2) (5.0 g, 4.16 mmol) was dissolved in 45 ml of ethylene chloride. Methansulfonyl chloride (0.513 g, 4.5 mmol) and triethylamine (0.454 g, 4.5 mmol) were added to the solution of (2) and the mixture was stirred at room temperature overnight. The reaction solution was washed sequentially with saturated aqueous sodium bicarbonate (2×20 ml) and water, and dried under vacuum over phosphorus pentoxide for two hours to give a-dimethoxytrityl-co-methylate (3), which was used step 2 without purification; MALDI MS: calc. (for n=19) (M)⁺1278.5; found (M+H)⁺1278.

Step 2. α-dimethoxytrityl-ω-azide (4). Methylate (3) and sodium azide (0.52 g, 8.0 mmol) were dissolved in 30 ml of dimethylformamide, and stirred at 60° C. for eight hours. The solvent was evaporated, the residue was dissolved in chloroform (50 ml), and that solution was washed sequentially with saturated aqueous sodium chloride (2×15 ml) and water (20 ml), dried with sodium sulfate, and evaporated. The resulting oil (4) was used step 3 without purification.

Step 3. α-dimethoxytrityl-ω-amine (5). Azido-PEG (4) and triphenyl phosphine (1.17 g, 4.5 mmol) were dissolved in 20 ml of dry pyridine, and stirred at room temperature for four hours. The reaction was treated with 20% aqueous ammonia (0.5 ml) and stirred for an additional three hours at 50° C. The formation of ω-amino-PEG 900 (5) was monitored by TLC (Kieselgel 60 F254, chloroform-methanol 8:1; Rf of (4)=0.5; Rf of (5)=0.2). Upon completion, the solvent was removed by evaporation. Purification by silica gel column chromatography (0-10% methanol gradient in chloroform) gave 3.75 g (75%) of (5); MALDI MS: calc. (for n=19) (M)⁺1199.6; found (M+H)^{+.}1200.6.

Example 3. N-(9-Fluorenylmethyloxycarbonyl)-PEG 900 (6). A 1 M sodium bicarbonate solution (6 ml) was added to a solution of DMTr-PEG-NH₂ (5) (3.6 g, 3 mmol) in acetonitrile (30 ml). A solution of N-(9-fluorenylmethoxycarbonyl) succinimide (1.11 g, 3.3 mmol) in 1,3-dioxane (10 ml) was added in one portion, and the mixture was stirred at room temperature for 30 minutes. After evaporation, the residue was diluted with 30 ml of water and extracted with ethylacetate (3×50 ml). The combined organic layer was washed sequentially with saturated aqueous sodium chloride and water, dried with sodium sulfate, and evaporated. The resulting oil was dissolved in 50 ml 80% acetic acid (50 ml), stirred for 30 minutes, and the resulting colored solution was evaporated. The resulting oil was dissolved in chloroform (50 ml) and washed sequentially with 5% aqueous sodium bicarbonate and water, dried over sodium sulfate, and evaporated. Purification by silica gel chromatography (0-6% methanol gradient in chloroform) gave 2.86 g (85%) of (6); MALDI MS: calc. (for n=19) (M)⁺1119.8, found (M)⁺1120.8.

Example 4. N-(9-Fluorenylmethoxycarbonyl)PEG 900-(2-cyanoethyl-N,N-diisopropyl)-phosphoroamidite (7). Fmoc-NH-PEG 900 (6) (1.12 g, 1 mmol) was evaporated from acetonitrile, dried in vacuum under phosphorus pentoxide overnight, and then dissolved in 20 ml of dry acetonitrile, which was treated with 1H-tetrazole (70 mg, 1 mmol) and 2-cyanoethyltetraisopropylphosphorodiamidite (361 mg, 1.2 mmol). After stirring for one hour at room temperature, the mixture was evaporated, diluted with 30 ml of ethylacetate, washed sequentially with saturated aqueous sodium bicarbonate and saturated aqueous sodium chloride, dried over sodium sulfate, and concentrated under vacuum to about 3-4 ml. The precipitate prepared by adding cold hexane was collected by filtration, and dried under vacuum to give 1.09 g (82%) of (7); ³¹P-NMR (CDCl₃, phosphoric acid as standard) δ147 ppm.

Example 5. General synthesis of PEG-oligodeoxyribonucleotide conjugates (8). Oligodeoxyribonucleotide syntheses were carried out on a 394 Applied Biosystems DNA/RNA Synthesizer in 1 μmol scale using 2-(cyanoethyl)-N,N-diisopropyl-d(A,C,G,T)-phosphoroamidites (available from GLEN Research). PEG-conjugation at the 5′-end of the resulting oligonucleotides was performed as the last step of the syntheses by coupling with a 0.12 M solution of PEG-phosphoramidite (7) in acetonitrile in the standard reaction cycle. After cleavage from the solid support and deprotection in 25% aqueous ammonia, the resulting PEG-oligonucleotide conjugates were purified by reverse phase HPLC. FIG. 2 shows HPLC profile of the PEG-oligonucleotide conjugate of 5′-agcttcagtaccagtccggg-3 prepared in this Example. DOCUMENTS CITED Carnon et al., in BioTechniques, 2002, 32-410 Greene and Wuts, in “Protective groups in organic synthesis,” ₂nd edition, John Wiley & Sons (NY 1991) Jaschke et al., Nucleic Acids Res. 1994, 22, 4810-4817 Zalipsky, in Bioconjugate Chem. 1995, 6, 150-165 Pirrung, in Angew.Chem.Int.Ed., 2002, 41, 1276-1289 Charles et al, in Langmuir, 2003, 19, 1586-1591

1. An oligonucleotide conjugate of the formula: 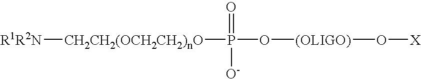
wherein R¹ and R² are each independently selected from the group consisting of hydrogen, amino protecting groups, a first solid support, and a first diagnostic agent; or R¹ and R² are taken together to form an amino protecting group, a first solid support, or a diagnostic agent; n is an integer in the range from about 8 to about 200; OLIGO is an oligonucleotide; and X is hydrogen, or a second solid support, or a second diagnostic agent.

2. The conjugate of claim 1 wherein R¹ is an amino protecting group and R² is hydrogen.

3. The conjugate of claim 1 wherein the amino protecting group is removable under basic or neutral conditions.

4. The conjugate of claim 1 wherein R¹ and R² are hydrogen.

5. The conjugate of claim 1 wherein R¹ is a first solid support and R² is hydrogen.

6. The conjugate of claim 1 wherein R¹ is a polyacrylamide gel and R² is hydrogen.

7. The conjugate of claim 1 wherein R¹ is controlled pore glass and R² is hydrogen.

8. The conjugate of claim 1 wherein R¹ is a first diagnostic agent selected from the group consisting of biotin, fluorescent agents, and antibodies; and R² is hydrogen.

9. The conjugate of claim 1 wherein n is an integer in the range from about 10 to about 30.

10. The conjugate of claim 1 wherein n is an integer in the range from about 14 to about 26.

11. The conjugate of claim 1 wherein X is a second solid support adapted for synthesis of an oligonucleotide.

12. The conjugate of claim 1 wherein X is hydrogen.

13. A reagent for preparing conjugates comprising a compound of the formula:
R¹R²N-CH₂CH₂-(O-CH₂CH₂)ₙ-OX
wherein R¹ and R² are each independently selected from the group consisting of hydrogen, amino protecting groups, a first solid support, and a first diagnostic agent; or R¹ and R² are taken together to form a amino protecting group; n is an integer in the range from about 8 to about 200; and X is hydrogen, an hydroxyl protecting group, or an optionally protected derivative of trivalent phosphorus.

14. The reagent of claim 13 wherein X is hydrogen.

15. The reagent of claim 13 wherein X is a phosphoramidite.

16. The reagent of claim 13 wherein X is (2-cyanoethyl)-N,N′-diisopropylaminophosphite.

17. The reagent of claim 13 wherein n is an integer in the range from about 10 to about 30.

18. The reagent of claim 13 wherein n is an integer in the range from about 14 to about 26.

19. The reagent of claim 13 wherein at least one of R¹ and R² is not hydrogen.

20. The reagent of claim 13 wherein R¹ is hydrogen, and R² is 9-fluorenylmethoxycarbonyl.

21. The reagent of claim 13 wherein the conjugates are formed from components selected from the group consisting of oligonucleotides, peptides, proteins, carbohydrates, biotin, diagnostic agents, fluorescent labels, drugs, affinity ligands, antibiotics, and combinations thereof.

22. A process for preparing the reagent of claim 13 comprising the step of:
converting a first compound of formula:
R³-CH₂CH₂-(O-CH₂CH₂)ₙ-OR⁴
to a second compound of formula:
N₃-CH₂CH₂-(O-CH₂CH₂)ₙ-OR⁴
where R³ is a leaving group; R⁴ is an oxygen protecting group; and n is an integer in the range from about 8 to about 200.

23. The process of claim 23 wherein the converting step includes a first compound wherein R³ is optionally substituted alkylsulfonyloxy or optionally substituted arylsulfonyloxy.

24. The process of claim 23 wherein the converting step includes a first compound wherein R³ is mesyloxy.

25. The process of claim 23 wherein the converting step includes a first compound and a second compound where R⁴ is a hydroxyl protecting group that is removable under acidic conditions.

26. The process of claim 23 wherein the converting step includes a first compound and a second compound where R⁴ is optionally substituted trityl.

27. The process of claim 23 wherein the converting step includes a first compound and a second compound where R⁴ is 4,4′-dimethoxytrityl

28. A process for preparing the oligonucleotide conjugate of claim 1, the process comprising the steps of:
(a) providing a solid support adapted for oligonucleotide synthesis
(b) synthesizing an oligonucleotide;
(c) deprotecting the 5′-OH of the oligonucleotide
(d) reacting the deprotected 5′-OH the oligonucleotide with a reagent comprising a compound of the formula:
R¹R²N-CH₂CH₂-(O-CH₂CH₂)ₙ-OX
wherein R¹ and R² are each independently selected from the group consisting of hydrogen and amino protecting groups, provided that at least one of R¹ and R² is not hydrogen; or R¹ and R² are taken together to form an amino protecting group; n is an integer in the range from about 8 to about 200; and X is an optionally protected derivative of trivalent phosphorus.

29. A biochip, comprising a solid support, and a plurality of oligonucleotide conjugates of the formula: 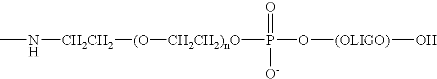
wherein n is an integer in the range from about 8 to about 200; and OLIGO is in each occurrence an independently selected oligonucleotide; and where each of the plurality of oligonucleotide conjugates is covalently attached to the solid support.

30. The biochip of claim 29 wherein the solid support is a glass slide.

31. The biochip of claim 29 wherein the solid support is a 2D or a 3D support.

32. A kit for preparing a biochip, the kit comprising (a) a solid support; and (b) an agent for covalently attaching one or more oligonucleotide conjugates to the solid support; where the one or more oligonucleotide conjugates are compounds of the formula: 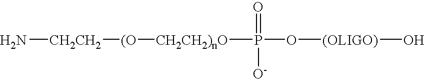
wherein n is an integer in the range from about 2 to about 200; and OLIGO is in each of the one or more oligonucleotide conjugates an independently selected oligonucleotide.

33. The kit of claim 32 wherein the solid support is a glass slide.

34. The kit of claim 32 wherein the solid support is a polyacrylamide gel.

35. The kit of claim 32 wherein the solid support is a 2D or a 3D support.

36. The kit of claim 32 wherein the agent is a reducing agent.

37. The kit of claim 32 wherein the agent is a borohydride reducing agent.

38. The kit of claim 32 wherein the agent is a carboxylic acid or sulfonic acid activating agent.

39. A terminal amino polyethylene glycol conjugate of the formula: 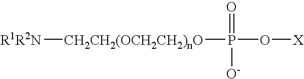
wherein R¹ and R² are each independently selected from the group consisting of hydrogen, amino protecting groups, a first solid support, and a first diagnostic agent; or R¹ and R² are taken together to form an amino protecting group, a first solid support, or the first diagnostic agent; n is an integer in the range from about 8 to about 200; and X is a molecule selected from the group consisting of oligonucleotides, peptides, proteins, carbohydrates, biotin, diagnostic agents, fluorescent labels, drugs, affinity ligands, and antibiotics.


SEQUENCE LISTING (1 sequence)

SEQ ID NO: 1 - DNA, 20 bp, Artificial Sequence
  Description of Artificial Sequence Synthetic polynucleotide sequence
agcttcagtaccagtccggg